(19) United States
(12) Patent Application Publication
(10) Pub. No.: US 2026/0158521 A1
(43) Pub. Date: Jun. 11, 2026

(54) MULTILAYER ARTICLES CONTAINING ORGANIC LAYERS

(71) Applicant: VIAVI SOLUTIONS INC., Chandler, AZ (US)

(72) Inventors: Alberto ARGOITIA, Santa Rosa, CA (US); Kangning Liang, Santa Rosa, CA (US); Johannes P. Seydel, Petaluma, CA (US)

(73) Assignee: VIAVI SOLUTIONS INC., Chandler, AZ (US)

(21) Appl. No.: 19/179,666

(22) Filed: Apr. 15, 2025

Related U.S. Application Data
(63) Continuation of application No. 16/735,329, filed on Jan. 6, 2020, now Pat. No. 12,285,779.
(60) Provisional application No. 62/789,387, filed on Jan. 7, 2019.

(51) Int. Cl. B05D 5/06; B05D 7/00; C09C 1/00; G02B 1/12; G02B 5/28

(52) U.S. Cl. CPC B05D 5/063; B05D 7/54; C09C 1/0015; G02B 1/12; C09C 2210/40; G02B 5/287

(57) ABSTRACT

An article includes a first organic layer and a second organic layer each with an interior embossed surface; and an embossed reflector layer adjacent to the interior embossed surface of the first organic layer and adjacent to the interior embossed surface of the second organic layer. A method of making an article is also disclosed.

### RELATED APPLICATIONS

The present application is a Continuation of commonly assigned and co-pending U.S. patent application Ser. No. 16/735,329, filed Jan. 6, 2020, which claims priority to U.S. Provisional Patent Application No. 62/789,387, filed on Jan. 7, 2019, the disclosures of which are hereby incorporated by reference in their entireties.

### FIELD OF THE INVENTION

The present disclosure generally relates to articles, such as optical devices in the form of foil, sheets, and/or flakes. The article can include a first organic layer and a second organic layer, wherein the first organic layer and the second organic layer each independently include an interior embossed surface; and an embossed reflector layer adjacent to the interior embossed surface of the first organic layer and adjacent to the interior embossed surface of the second organic layer. Methods of making the article, such as an optical device, e.g., a diffractive pigment, are also disclosed.

### BACKGROUND OF THE INVENTION

Many products can be made on a substrate with a release layer, such as sodium chloride. The release layer is evaporated under vacuum prior to coating. Additionally, a multilayer design to make flakes is deposited under vacuum on microstructured substrate foils. Once coated, the multilayer design is stripped off in a wet process that dissolves the release layer using a mixture of acetone and water. The stripped flakes are dried, then milled by grinding to obtain a final desired particle size distribution. Non-limiting examples of dry or wet grinding techniques include jet mill, cryogenic, ultrasonic on liquid media, Rotor-Stator mill wet grinding, etc. The described processes require a large number of steps to be performed by different equipment resulting in increased manufacturing costs and making the end product, a pigment, expensive.

What is needed is an article that can be prepared in a process utilizing fewer pieces of equipment resulting in lower manufacturing costs.

### SUMMARY OF THE INVENTION

In an aspect, there is disclosed an article including a first organic layer and a second organic layer, wherein the first organic layer and the second organic layer each include an interior embossed surface; and an embossed reflector layer adjacent to the interior embossed surface of the first organic layer and adjacent to the interior embossed surface of the second organic layer.

In a further aspect, there is disclosed a method of making a diffractive pigment, including coating a first colored, organic layer onto a substrate; depositing a reflector layer onto the first colored, organic layer; and embossing both of the reflector layer and the first colored, organic layer.

In a further aspect, there is disclosed a method of making a diffractive pigment, including coating a first colored, organic layer onto a substrate; embossing the coated first colored, organic layer; and depositing a reflector layer onto the embossed first colored, organic layer, wherein the reflector layer conforms to an embossed surface of the embossed first colored, organic layer.

Additional features and advantages of various embodiments will be set forth, in part, in the description that follows, and will, in part, be apparent from the description, or can be learned by the practice of various embodiments. The objectives and other advantages of various embodiments will be realized and attained by means of the elements and combinations particularly pointed out in the description herein.

### BRIEF DESCRIPTION OF THE DRAWINGS

The present disclosure in its several aspects and embodiments can be more fully understood from the detailed description and the accompanying drawings, wherein:

FIG. 1 is a cross-section of an article including a first organic layer, a reflector layer, and a second organic layer, according to an aspect of the present disclosure;

FIG. 2 is a cross-section of an article including a first absorber layer, a first organic layer, a reflector layer, a second organic layer, and a second absorber layer, according to another aspect of the present disclosure;

FIG. 3 is a cross-section of an article including alternating layers of a first organic layer and a second organic layer, according to another aspect of the present disclosure;

FIGS. 4A-4D illustrate various steps in a method of making an article, according to an aspect of the present disclosure;

FIGS. 5A-5E illustrate various steps in a method of making an article, according to another aspect of the present disclosure;

FIG. 6 illustrates a cross-section of an article in which every surface of every layer is embossed;

FIG. 7 illustrates a cross-section of an article in which exterior surfaces of exterior layers are planar and every interior surface of every layer is embossed; and

FIG. 8 illustrates a cross-section of an article in which one exterior surface of one exterior layer is planar, another exterior surface of another exterior layer is embossed, and every interior surface of every layer is embossed.

Throughout this specification and figures like reference numbers identify like elements.

### DETAILED DESCRIPTION OF THE INVENTION

It is to be understood that both the foregoing general description and the following detailed description are exemplary and explanatory only, and are intended to provide an explanation of various embodiments of the present teachings.

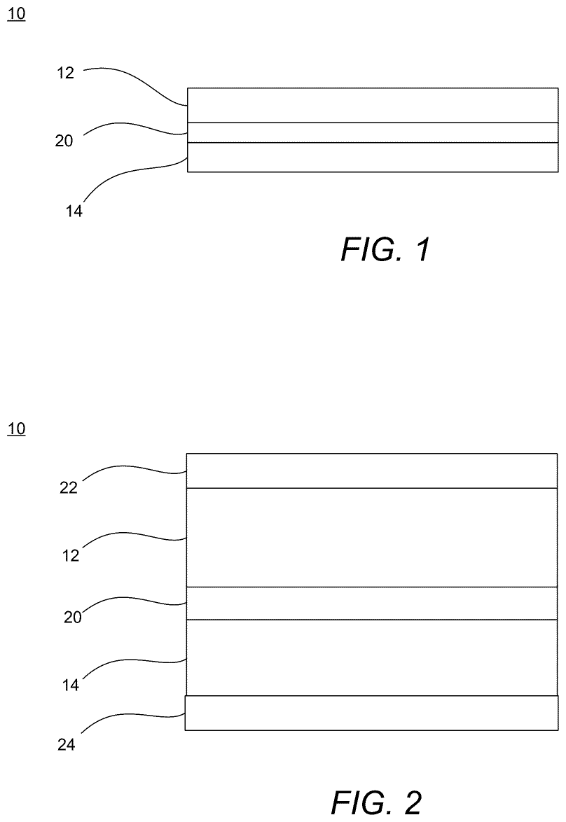

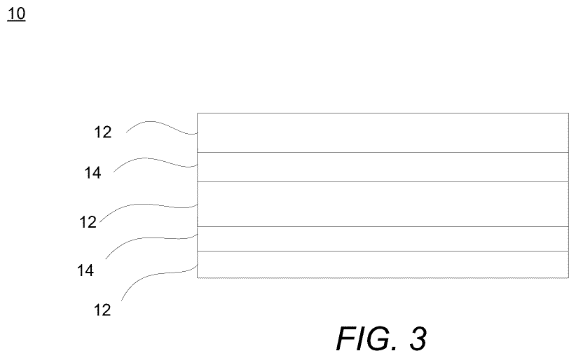

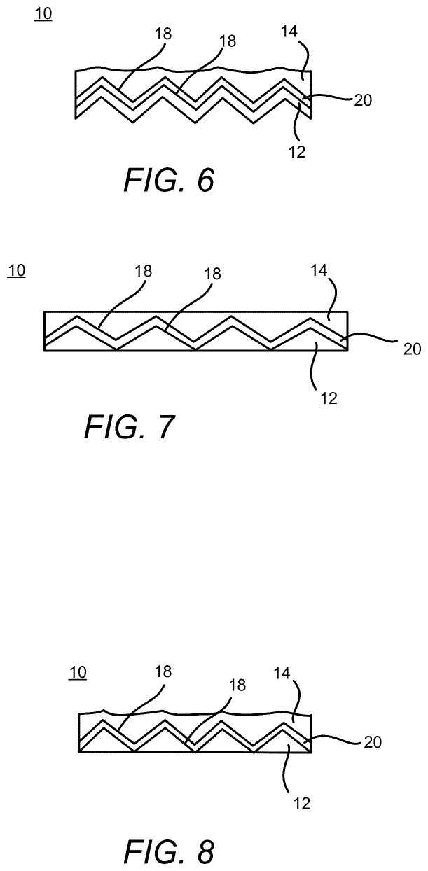

In its broad and varied embodiments, disclosed herein are articles, such as optical devices, for example, in the form of foils, sheets, and flakes; and a method of manufacturing the article 10. The article 10 can include multiple layers such as a three-layer structure as shown in FIG. 1, a five-layer structure, as shown in FIG. 2, and an alternative 5-layer structure as shown in FIG. 3. The layers present in the article 10 include but are not limited to, an organic layer 12, 14, a reflector layer 20, magnetic layer, an absorber layer 22, 24, and etc. The individual layers of the article 10 are more fully disclosed below. In an aspect, all layers of the article 10 can be embossed or otherwise microstructured, for example, as shown in FIGS. 6-8. In another aspect, one or more of the layers of the article 10 can be embossed. In a further aspect, one or more surfaces of one or more layers of the article 10 can be embossed, for example as shown in FIGS. 6-8. In yet another aspect, one or more surfaces of one or more layers of the article 10 can be planar, e.g., self-leveled, for example, as shown in FIGS. 7-8.

The article 10 can be symmetric, i.e., a core layer with the same type and same number of layers on both sides of the core layer. The materials that form the layers in a symmetric article 10 can be different. For example, the article 10 can include a first organic layer 12, a reflector layer 20, and a second organic layer 14, wherein the material that forms the first organic layer 12 is the same or different from the material that forms the second organic layer 14. In another aspect, the article 10 can be asymmetric, i.e., a core layer with different types and different number of layers on both sides of the core layer. The materials that form the layers in an asymmetric article 10 can be different. For example, the article 10 can include a reflector layer 20, an organic layer 12, and an absorber layer 22.

FIGS. 1-3 illustrate various multilayer structures as article 10 and do not exhibit embossing in order to simplify the illustrations. FIGS. 6-8 illustrate various embossed articles 10, but do not exhibit various multilayer articles 10 also to simplify the illustrations. It is intended that any article 10 in FIGS. 1-3 can be embossed in any manner illustrated in FIGS. 6-8. It is also intended that a description of a particular layer, such as a reflector layer 20, is applicable to any article 10 including that particular layer, such as a reflector layer. Additionally, it is intended that reference to a layer, is equally applicable to a first layer and a second layer, for example “organic layer,” “first organic layer 12,” and “second organic layer 14,” unless specified otherwise.

FIG. 1 illustrates a cross-section of an article 10 including a first organic layer 12, a reflector layer 20, and a second organic layer 14. The first organic layer 12 and the second organic layer 14 can each include an interior embossed surface 18; and an embossed reflector layer 20 adjacent to the interior embossed surface 18 of the first organic layer 12 and adjacent to the interior embossed surface 18 of the second organic layer 14. See, e.g., FIGS. 6-8.

The first organic layer 12 and the second organic layer 14 can be the same or different. For example, the first organic layer 12 and the second organic layer 14 can be the same color or can be different colors. In an aspect, the first organic layer 12 and the second organic layer 14 can each be clear. The first organic layer 12 and the second organic layer 14 can include the same or different organic materials.

Although not shown in FIG. 1, any surface of any of the layers present in the article 10 can be embossed or planar. For example, the first organic layer 12 and the second organic layer 14 can each include an interior embossed surface 18, such as the surface adjacent to the reflector layer 20, as shown in FIGS. 6-8. The reflector layer 20 of FIG. 1 can be fully embossed e.g., so that each surface is adjacent to the interior embossed surface 18 of the first organic layer 12 and the interior embossed surface of the second organic layer 14.

In another aspect, the reflector layer 20 can be partially embossed, for example, one surface that is embossed, such as the surface adjacent to the first organic layer 12 and another surface is planar, such as the surface adjacent to the second organic layer 14. Additionally, a partially embossed reflector layer 20 could include a portion, along a length, of both surfaces adjacent to the first organic layer 12 and the second organic layer 14 that is embossed, and another portion, along the remainder of the length, of both surfaces adjacent to the first organic layer 12 and the second organic layer 14 that is planar.

Although not shown in FIG. 1, an article 10 can include, the first organic layer 12 having an exterior planar surface and an interior embossed surface; the second organic layer 14 can include an exterior planar surface and an interior embossed surface; and the reflector layer 20 can include two oppositely oriented embossed surfaces, as shown in FIG. 7. In another aspect, the article 10 can include a first organic layer 12, a reflector layer 20, and a second organic layer 14 each with two oppositely oriented embossed surfaces, as shown in FIG. 6. In yet another aspect, the article 10 can include a first organic layer 12 having an exterior planar surface and an interior embossed surface 18, a fully embossed reflector layer 20, i.e., two oppositely oriented embossed surfaces, and a second organic layer 14 fully embossed, as shown in FIG. 6.

It should be noted that the degree of embossing can vary throughout an article 10. It is possible that the depth of the grooves (modulation) of the embossing is not the same between opposite surfaces of the article 10. The modulation affects the intensity of a particular diffractive wavelength but not the spatial position of the diffracted light. Therefore, a slight modulation on one side can be compensated by a deeper modulation on the other side of the article, as shown in FIG. 6.

Referring back to FIG. 1, in an aspect, the organic layer 12, 14 can be a composite of an organic material and a colorant, such as organic pigments, inorganic pigments, and dyes.

Non-limiting examples of organic colored material includes perylene, perinone, quinacridone, quinacridonequinone, anthrapyrimidine, anthraquinone, anthanthrone, benzimidazolone, disazo condensation, azo, quinolones, xanthene, azomethine, quinophthalone, indanthrone, phthalocyanine, triarylcarbonium, dioxazine, aminoanthraquinone, isoindoline, diketopyrrolopyrrole, thioindigo, thiazineindigo, isoindoline, isoindolinone, pyranthrone, isoviolanthrone, miyoshi methane, triarylmethane, or mixtures thereof

The organic material can include materials with thermoplastic properties, for example, materials with softening temperatures lower than a heat distortion of a heat resistant substrate 26. Non-limiting examples of the organic material include thermoplastics, such as polyesters, polyolefins, polycarbonates, polyamides, polyimides, polyurethanes, acrylics, acrylates, polyvinylesters, polyethers, polythiols, silicones, fluorocarbons, and various co-polymers thereof; thermosets, such as epoxies, polyurethanes, acrylates, melamine formaldehyde, urea formaldehyde, and phenol formaldehyde; and energy curable materials, such as acrylates, epoxies, vinyls, vinyl esters, styrenes, and silanes. Non-limiting examples of materials with thermoplastic properties include acrylic polymers, polyvinyl chloride, polystyrene, acrylic/nitrocellulose blends, acrylic/epoxy hybrids, styrene/acrylic, polyvinyl acetate, and polyvinyl alcohol. The thermal softening characteristics are defined in terms of the glass transition temperature (Tg).

In an aspect, the organic layer 12, 14 includes a material with a Tg value in the range of about 20° C. to about 150° C. In the case that the Tg is too low, the organic layer 12, 14 can become too “tacky” and difficult to remove from the embossing master without compromising the embossed microstructure. If the Tg is too high, the temperature required to soften the lay can also compromise the properties of the organic layer 12, 14.

In another aspect, the organic layer 12 can include a composite of the organic material disclosed herein, and light emitter nanoparticles. The light emitter nanoparticles can emit light when bombarded by an external source of radiation, such as an electromagnet or electrons. Non-limiting examples of light emitter nanoparticles include fluorescent nanoparticles and double converter nanoparticles.

FIG. 2 illustrates an article 10 including a first absorber layer 22, a first organic layer 12, a reflector layer 20, a second organic layer 14, and a second absorber layer 24. The article 10 and the layers present in the article 10 of FIG. 2 can be fully or partially embossed as discussed above with regard to FIG. 1, and as illustrated in FIGS. 6-8. Additionally, the first and second absorber layers 22, 24, can each independently include an embossed interior surface, an exterior planar surface, and/or two oppositely oriented embossed surfaces.

In an aspect, the organic layer 12, 14 can include organic, colored, dielectric material. The organic, colored, dielectric material can influence the thin film interference response of the design by selectively absorbing wavelengths of the incident and reflected light. The dielectric material can also be clear. Organic, dielectric material can have low index of refraction that can create an interference that can shift as a function of the incident light and viewing angle. A colorant can be used to color the dielectric material.

Dielectric materials can have various indices of refraction, such as low-index (less than about 1.6), medium-index (between about 1.6 and 2.0), and high-index (greater than about 2.0). Non-limiting examples of dielectric materials include SiO₂, TiO₂, Al₂O₃, ZrO₂, WO₃, VO₅, ITO, Ta₂O₅, CeO₂, Y₂O₃, ZnS, ZnO, In₂O₃, La₂O₃, MgO, Nd₂O₃, Pr₆O₁₁, Fe₂O₃, Fe₃O₄, SiO, SnO₂, FeOx, MgF₂, AlF₃, CeF₃, LaF₃, LiF, CaF₂, cermets, diamond-like carbon, and combinations thereof.

In another aspect, the organic layer 12, 14 can include a composite of organic index influencing nanoparticles and inorganic index influencing nanoparticles. For example, the inorganic index influencing nanoparticles can include TiO₂ or ZnS, which create an optical interference that will not change much as a function of the incident and viewing angles.

FIG. 3 illustrates an article 10 including alternating layers of a first organic layer 12 and a second organic layer 14. The article 10 does not include a reflector layer 20. The article 10 and the layers present in the article 10 of FIG. 3 can be fully or partially embossed as discussed above with regard to FIG. 1, and as illustrated in FIGS. 6-8. In this aspect, the first organic layer 12 can include a composite of high index organic material and inorganic dielectric nanoparticles; and the second organic layer 14 includes a composite of low index organic dielectric material.

FIG. 3 can further include a first absorber layer 22 and a second absorber layer 24, as the exterior layers of the article 10. The first absorber layer 22 and the second absorber layer 24 can intensify the color of the first and second organic layers 12, 14.

The reflector layer 20 for use in the article 10 disclosed herein can include metals and/or metal alloys. In one example, any materials that have reflective characteristics can be used. Non-limiting examples of material with reflecting properties include aluminum, silver, copper, gold, platinum, tin, titanium, palladium, nickel, cobalt, rhodium, niobium, chromium, and compounds, combinations or alloys thereof. Examples of other suitable reflective alloys and compounds include bronze, brass, titanium nitride, and the like, as well as alloys of the metals listed above such as silver-palladium. The reflector layer 20 can have an inherent color such as copper, gold, silver copper alloys, brass, bronze, titanium nitride, and compounds, combinations or alloys thereof.

The reflector layer 20 can be produced by the incorporation of particles with reflecting properties into an organic matrix. A silver reflector layer 20 can be deposited using a variant of the Brashear silver process

The absorber layer 22, 24 can include any absorber material, including both selective absorbing materials and nonselective absorbing materials. For example, the absorber layer 22, 23 can be formed of nonselective absorbing metallic materials deposited to a thickness at which the absorber layer is at least partially absorbing, or semi-opaque. An example of a non-selective absorbing material can be a gray metal, such as chrome or nickel. An example of a selective absorbing material can be copper or gold. In an aspect, the absorbing material can be chromium. Non-limiting examples of suitable absorber materials include metallic absorbers such as chromium, aluminum, silver, nickel, palladium, platinum, titanium, vanadium, cobalt, iron, tin, tungsten, molybdenum, rhodium, niobium, carbon, graphite, silicon, geranium, cermet and various combinations, mixtures, compounds, or alloys of the above absorber materials that may be used to form the absorber layer 22, 24.

Examples of suitable alloys of the above absorber materials can include Inconel (Ni—Cr—Fe), stainless steels, Hastalloys (Ni—Mo—Fe; Ni—Mo—Fe—Cr; Ni—Si—Cu) and titanium-based alloys, such as titanium mixed with carbon (Ti/C), titanium mixed with tungsten (Ti/W), titanium mixed with niobium (Ti/Nb), and titanium mixed with silicon (Ti/Si), and combinations thereof. Other examples of suitable compounds for the absorber layer 22, 24 include titanium-based compounds such as titanium silicide (TiSi₂), titanium boride (TiB₂), and combinations thereof. Alternatively, the absorber layer 22, 24 can be composed of a titanium-based alloy disposed in a matrix of Ti, or can be composed of Ti disposed in a matrix of a titanium-based alloy.

In an aspect, the organic layer 12, 14 can be a selective light modulator layer (SLML). The SLML is a physical layer comprising a plurality of optical functions aiming at modulating (absorbing and or emitting) light intensity in different, selected regions of spectrum of electromagnetic radiation with wavelengths ranging from about 0.2 μm to about 20 μm. The SLML can selectively modulate light by means of absorption provided by a selective light modulator system (SLMS) (discussed in more detail below).

The SLML (including each SLML present in an article, if multiple layers are present) can each independently comprise a host material alone, or a host material combined with a selective light modulator system (SLMS). The SLMS can include a selective light modulator molecule (SLMM), a selective light modulator particle (SLMP), an additive, or combinations thereof.

The host material of the SLML can independently be a film forming material applied as a coating liquid and serving optical and structural purposes. The host material can be used as a host (matrix) for introducing, if necessary, a guest system, such as the selective light modulator system (SLMS), for providing additional light modulator properties to the article.

The host material can be a dielectric material. Additionally, or alternatively, the host material can be at least one of an organic material (as disclosed above), an inorganic polymer, and a composite material, such as those composite materials discussed above with regard to the organic layer 12, 14. Non-limiting examples of inorganic polymers includes silanes, siloxanes, titanates, zirconates, aluminates, silicates, phosphazanes, polyborazylenes, and polythiazyls.

The SLMS, for use in the SLML with the host material, can each independently comprise selective light modulator particles (SLMP), selective light modulator molecules (SLMM), additives, or a combination thereof. The SLMS can also comprise other materials.

The SLML can each independently include in an SLMS a SLMP. The SLMP can be any particle combined with the host material to selectively control light modulation, including, but not limited to color shifting particles, colorants include colorant includes one or more of dyes (such as a phthalocyanine-based compound), inorganic pigments, organic pigments, reflective pigments, color shifting pigments, quantum dots, selective reflectors, nanoparticles (selectively reflecting and/or absorbing), and micelles, etc. The nanoparticles can include, but are not limited to organic and metalorganic materials having a high value of refractive index (n>1.6 at wavelength of about 550 nm); metal oxides, such as TiO₂, ZrO₂, In₂O₃, In₂O₃—SnO, SnO₂, FeₓO_{y} (wherein x and y are each independently integers greater than 0), and WO₃; metal sulfides, such as ZnS, and CuₓS_{y} (wherein x and y are each independently integers greater than 0); chalcogenides, quantum dots, metal nanoparticles; carbonates; fluorides; and mixtures thereof.

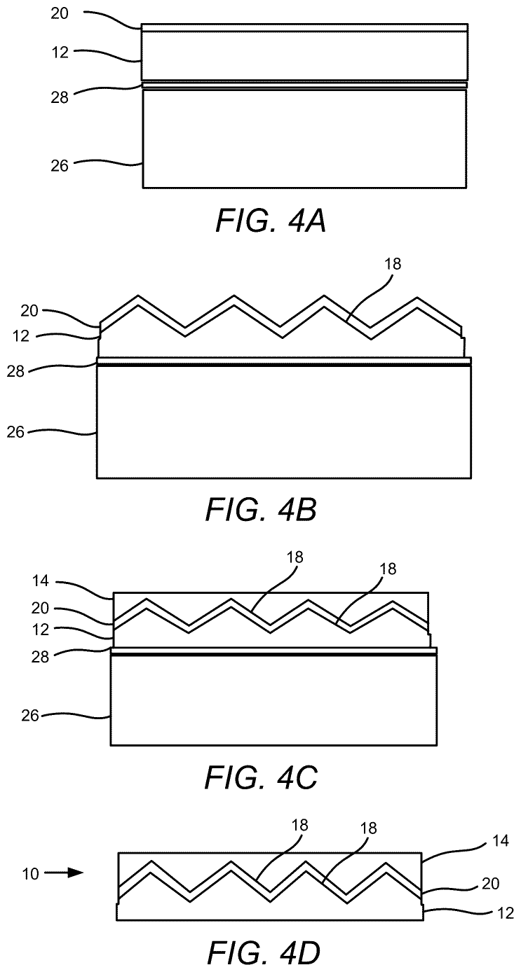

The article 10 disclosed herein can be formed using at least two different methods. In an aspect, there is disclosed a method of making an article 10, such as a diffractive pigment, including coating a first organic layer 12 onto a substrate 26, as shown in FIG. 4A. The first organic layer 12 can be coated using a liquid coating process. The liquid coating process allows the first organic layer 12 to self-level thereby providing planar exterior surfaces. A reflector layer 20 can be deposited onto the first organic layer 12 using any deposition technique, including vacuum deposition processes, and liquid coating processes.

The method can further include heating the reflector layer 20 deposited on the first organic layer 12 prior to embossing. The deposited layers can be heated to a temperature higher than a softening temperature of the first organic layer 12.

As shown in FIG. 4B, both of the reflector layer 20 and the first organic layer 12 can be embossed. Embossing can occur through at least one of temperature and pressure contact with an embossing master. A discontinuous embossing system can be used wherein the substrate/coated layers, for example, as shown in FIG. 4A, can be moved by discrete steps under an embossing plate. Alternatively, the embossing master can be an embossing roller that is heated to a temperature below the thermoplastic softening temperature of the first organic layer 12.

As shown in FIG. 4C, the method can further include coating a second organic layer 14 onto the embossed reflector layer 20. The second organic layer 14 can be coated using a liquid coating process. The liquid coating process allows the second organic layer 14 to self-level thereby providing a planar exterior surface and an interior embossed surface.

The layers of the article 10 can be present in a solvent or water base solution. In this manner, the layers can be coated/applied/deposited using a liquid coating process. Non-limiting example of a liquid coating process include slot-die, gravure, microgravure, inkjet, curtain coating, metering rod, myer bar coating, flexo, offset printing, slot-bead, slide bead, slot curtain, slide curtain, tensioned web and reverse roll, and other liquid coating and printing processes that apply a liquid on to a substrate or previously deposited layer to form a liquid layer or film that is subsequently dried and/or cured. The liquid coating process can allow for the transfer of the composition of the layer, such as the organic layer 12, 14, at a faster rate as compared to other deposition techniques, such as vapor deposition. Additionally, the liquid coating process can allow for a wider variety of materials to be used in the layer with a simple equipment set up. It is believed that the layer formed using the disclosed liquid coating process can exhibit improved optical performance.

The method can further include releasing the substrate 26 thereby forming an article 10, as shown in FIG. 4D. In an aspect, the substrate 26 can include a release layer 28. The release layer 28 can have a lower adhesion to the first organic layer 12 as compared to the substrate 26. In an aspect, the release layer 28 is water soluble and can be eliminated.

The substrate 26 can be released from the deposited layers to create the article 10. In an aspect, the substrate 26 can be cooled to embrittle an associated release layer 28, if present. In another aspect, the release layer 28 could be embrittled for example by heating and/or curing with photonic or e-beam energy, to increase the degree of cross-linking, which would enable stripping. The deposited layers can then be stripped mechanically, such as sharp bending or brushing of the surface. The released and stripped layers can be sized into article 10, such as an optical device in the form of a flake, foil, or sheet, using known techniques.

The method can further include applying a chilling drum to the embossed layers (reflector/first organic layer 12) to remove the heat provided by the embossing roller/plate. Embossing can provide a diffractive pattern, hologram, symbols, logos, or any other suitable microstructure to the deposited layers.

The substrate 26 can include a material that is heat resistant, such as a polyester, a polyamide, polyvinyl chloride, or propylene. The substrate 26 can be present in a roll configuration so that the layers of the article 10 are deposited onto the substrate 26 as it moves from an unwind to a rewind roll configuration. The substrate 26 can include a material that has a softening temperature that is higher than a softening temperature of the multiple layers, such as the organic layer 12, 14. The substrate 26 can be made of a flexible material. The substrate 26 can be any suitable material that can receive multiple layers deposited during the manufacturing process. Non-limiting examples of suitable substrate materials include polymer web, such as polyethylene terephthalate (PET), glass foil, glass sheets, polymeric foils, polymeric sheets, metal foils, metal sheets, ceramic foils, ceramic sheets, ionic liquid, paper, silicon wafers, etc. The substrate can vary in thickness, but can range for example from about 2 μm to about 100 μm, and as a further example from about 10 μm to about 50 μm.

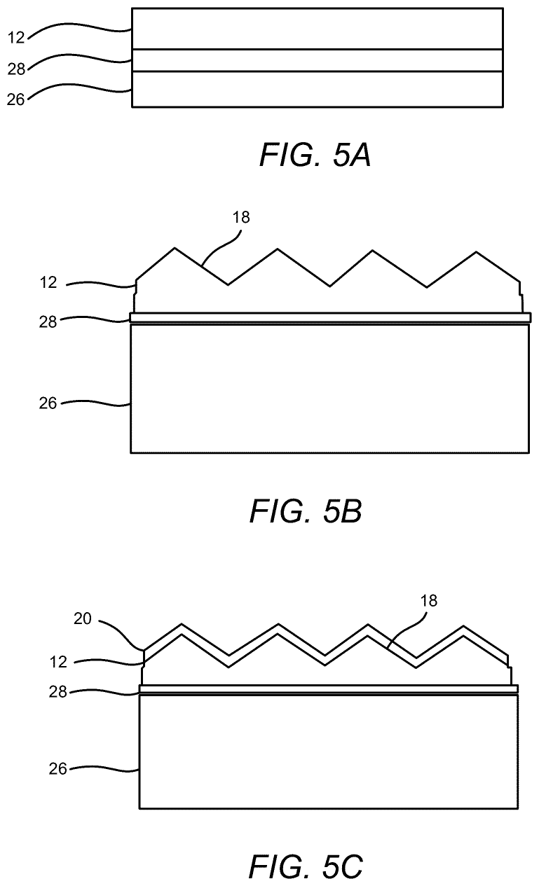

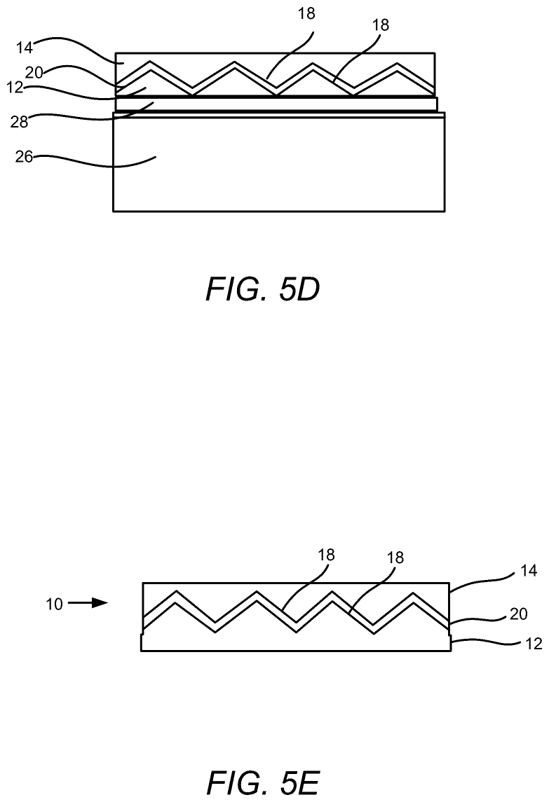

In an aspect, there is also disclosed a method of making an article 10, as shown in FIGS. 5A-5E. The method can include coating a first organic layer 12 onto a substrate 26, optionally including a release layer 28. The first organic layer 12 can be coated using a liquid coating process. As shown in FIG. 5B, the method can include embossing the coated first organic layer 12 to produce an interior embossed surface 18. The method can include depositing a reflector layer 20 onto the interior embossed first organic layer 12. In this manner, the reflector layer 20 conforms to the interior embossed surface 18 of the embossed first organic layer 12, as shown in FIG. 5C.

The method can further include coating a second organic layer 14 onto the deposited reflector layer 20, as shown in FIG. 5D. The second organic layer 14 can be coated using a liquid coating process.

As shown in FIG. 5E, the substrate 26, and the optional release layer can be removed from the article 10.

In an aspect, the methods can include embossing a first organic layer 12 followed by deposition of the reflector layer 20 and deposition of the second organic layer 14. This method can result in the article 10 illustrated in FIG. 6. Alternatively, the method can include depositing the first organic layer 12, depositing the reflector layer 20, embossing both the first organic layer 12 and the reflector layer 20, and depositing the second organic layer 14. The article 10 has differing modulation on opposite exterior surfaces of the article. In this manner, the article 10 is asymmetric because the degree of modulation on opposite exterior surfaces is different. Statistically, 50% of the articles 10, such as flakes, having the less modulated second organic layer 14 will lie facing up, and 50% of the articles 10 having the more modulated first organic layer 12 will lie facing up, providing different diffractive effects. FIG. 8 could also be considered asymmetric because the degree of modulation on opposite exterior surfaces is different. FIG. 7 could be considered symmetric.

Additionally, or alternatively, the article 10, in the form of a flake, sheet, or foil, can also include a hard coat or protective layer. In some examples, these layers (hard coat or protective layer) do not require optical qualities.

Depending on the thermoplastic properties of the article 10 and the release layer 28, an embossing layer can be included between the substrate 26 and the release layer 28. This embossing layer can be part of the article 10. In an aspect, the release layer 28 can be eliminated or introduced between the substrate 26 and the embossable layer.

From the foregoing description, those skilled in the art can appreciate that the present teachings can be implemented in a variety of forms. Therefore, while these teachings have been described in connection with particular embodiments and examples thereof, the true scope of the present teachings should not be so limited. Various changes and modifications can be made without departing from the scope of the teachings herein.

This scope disclosure is to be broadly construed. It is intended that this disclosure disclose equivalents, means, systems and methods to achieve the devices, activities and mechanical actions disclosed herein. For each device, article, method, mean, mechanical element or mechanism disclosed, it is intended that this disclosure also encompass in its disclosure and teaches equivalents, means, systems and methods for practicing the many aspects, mechanisms and devices disclosed herein. Additionally, this disclosure regards a coating and its many aspects, features and elements. Such a device can be dynamic in its use and operation, this disclosure is intended to encompass the equivalents, means, systems and methods of the use of the device and/or optical device of manufacture and its many aspects consistent with the description and spirit of the operations and functions disclosed herein. The claims of this application are likewise to be broadly construed. The description of the inventions herein in their many embodiments is merely exemplary in nature and, thus, variations that do not depart from the gist of the invention are intended to be within the scope of the invention. Such variations are not to be regarded as a departure from the spirit and scope of the invention.

What is claimed is:

1. A diffractive pigment, comprising:
a stack including alternating layers of a high refractive index layer and a low refractive index layer, the low refractive index layer comprising organic material and including a first side and a second side that is opposite the first side, the high refractive index layers comprising organic material and refractive index inorganic nanoparticles,
wherein the layers of the high refractive index layer include a first high refractive index layer on the first side of the low refractive index layer and a second high refractive index layer on the second side of the low refractive index layer,
wherein at least one layer of the stack includes an embossed surface.

2. The diffractive pigment of claim 1, wherein the pigment does not include a reflector layer.

3. The diffractive pigment of claim 1, wherein one or more surfaces of one or more alternating layers of the stack are self-leveled.

4. The diffractive pigment of claim 1, wherein the at least one layer of the stack is partially embossed.

5. The diffractive pigment of claim 1, wherein each layer of the alternating layers of the stack is partially embossed.

6. The diffractive pigment of claim 1, wherein each layer of the alternating layers of the stack is fully embossed.

7. The diffractive pigment of claim 1, wherein the stack further includes a second low refractive index layer on the second high refractive index layer.

8. The diffractive pigment of claim 7, wherein the stack further includes a third high refractive index layer on the second low refractive index layer.

9. The diffractive pigment of claim 1, wherein a first surface of the alternating layers have a different modulation then a second surface of the alternating layers.

10. The diffractive pigment of claim 1, wherein a first exterior surface of the diffractive pigment is embossed to have a different modulation as compared to a modulation of a second exterior surface of the diffractive pigment.

11. The diffractive pigment of claim 1, wherein the at least one layer of the stack that is embossed includes a diffractive pattern, hologram, symbol or logo.

12. The diffractive pigment of claim 1, wherein the at least one layer of the stack that is embossed includes a microstructure.

13. The diffractive pigment of claim 1, wherein at least one surface of at least one layer of the stack is a non-embossed surface.

14. The diffractive pigment of claim 13, wherein a second surface of the at least one layer of the stack is opposite the non-embossed surface, and the second surface is embossed.

15. The diffractive pigment of claim 1, wherein the stack of alternating layers includes a core.

16. The diffractive pigment of claim 15, wherein the core layer is the second high refractive index layer.

17. The diffractive pigment of claim 1, wherein first high refractive index layer

18. The diffractive pigment of claim 1, wherein one or more surfaces of one or more alternating layers of the article are planar.
